(19) United States
(12) Patent Application Publication
(10) Pub. No.: US 2026/0346787 A1
(43) Pub. Date: Nov. 5, 2026

(54) VEHICULAR CABIN MONITORING SYSTEM WITH RADAR SENSOR IN MIRROR HEAD

(71) Applicant: Magna Mirrors of America, Inc., Holland, MI (US)

(72) Inventors: James J. Ferri, Maple (CA); Austen C. Peterson, Hudsonville, MI (US); Nathan J. Pastoor, Jenison, MI (US); Kenneth C. Peterson, Grand Rapids, MI (US)

(21) Appl. No.: 19/666,810

(22) Filed: May 4, 2026

Related U.S. Application Data
(60) Provisional application No. 63/799,821, filed on May 5, 2025.

(51) Int. Cl. B60R 1/12; B60K 35/10; B60K 35/22; B60K 35/28; B60K 35/53; B60R 1/04; B60R 1/08; G01S 7/03; G01S 13/62

(52) U.S. Cl. CPC B60R 1/12; B60K 35/10; B60K 35/22; B60K 35/28; B60K 35/53; B60R 1/04; B60R 1/088; G01S 7/03; G01S 13/62; B60K 2360/146; B60K 2360/164; B60K 2360/779; B60R 2001/1223; B60R 2001/1253; B60R 2001/1261

(57) ABSTRACT

A vehicular cabin monitoring system includes an interior rearview mirror assembly that accommodates a radar sensor that senses within an interior cabin of a vehicle. The radar sensor includes an antenna array that emits radio waves that pass through a portion of the mirror head and receives radio waves that reflect from objects within the interior cabin and pass through the portion of the mirror head. The cabin monitoring system includes an electronic control unit (ECU) including electronic circuitry and associated software, and the electronic circuitry includes a processor operable to process sensor data captured by the radar sensor and transferred to the ECU. The cabin monitoring system monitors at least a driver of the vehicle via processing at the ECU sensor data captured by the radar sensor.

### CROSS REFERENCE TO RELATED APPLICATION

The present application claims the filing benefits of U.S. provisional application Ser. No. 63/799,821, filed May 5, 2025, which is hereby incorporated herein by reference in its entirety.

### FIELD OF THE INVENTION

The present invention relates generally to a vehicular cabin monitoring system for a vehicle and, more particularly, to a vehicular cabin monitoring system that utilizes one or more radar sensors at a vehicle.

### BACKGROUND OF THE INVENTION

Use of radar sensors in vehicle sensing systems is common and known.

Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular cabin monitoring system includes a vehicular interior rearview mirror assembly that includes a mirror head adjustable about a mounting structure. The mounting structure is configured to mount the vehicular interior rearview mirror assembly at an interior portion of an interior cabin of a vehicle. The mirror head accommodates a mirror reflective element. A radar sensor is accommodated by the vehicular interior rearview mirror assembly. With the vehicular interior rearview mirror assembly mounted at the interior portion of the interior cabin of the vehicle, the radar sensor senses within the interior cabin of the vehicle. The mirror reflective element moves together and in tandem with the mirror head when, with the vehicular interior rearview mirror assembly mounted at the interior portion of the interior cabin of the vehicle, the mirror head is adjusted about the mounting structure to provide a rearward view for a driver of the vehicle provided by the mirror reflective element. Sensor data captured by the radar sensor is transferred to an electronic control unit (ECU), which includes a processor operable to process the sensor data. The vehicular cabin monitoring system, via processing at the ECU of sensor data captured by the radar sensor, monitors a passenger region within the interior cabin of the vehicle.

These and other objects, advantages, purposes and features of the present invention will become apparent upon review of the following specification in conjunction with the drawings.

### BRIEF DESCRIPTION OF THE DRAWINGS

FIG. 1 is a side view of a vehicle with a cabin monitoring system that utilizes radar sensors;

FIG. 2 is a perspective view of an interior rearview mirror assembly of the vehicle that accommodates a radar sensor;

FIGS. 3A-3D are schematic views of the interior rearview mirror assembly and radar sensor, showing example mounting positions of the radar sensor and the resultant field of sensing within the interior cabin of the vehicle;

FIG. 4 shows the radar sensor disposed at mounting structure of the interior rearview mirror assembly;

FIG. 5 is a schematic view of the interior rearview mirror assembly with the radar sensor disposed at a ball member of the mounting structure;

FIG. 6 is a schematic view of the interior rearview mirror assembly with the radar antenna array of the radar sensor disposed within the mirror head remote from a radar signal processing unit of the radar sensor;

FIG. 7 is a schematic view of the interior rearview mirror assembly with the radar sensor disposed as a unitary module at a lower edge portion of the mirror head;

FIG. 8 is a schematic view of the interior rearview mirror assembly with a radar absorbing shield disposed between the radar sensor and a rear side of the mirror reflective element;

FIG. 9 is a schematic view of the interior rearview mirror assembly with the mirror reflective element having a non-conductive reflector and the radar sensor sensing at least partially through the mirror reflective element;

FIG. 10 is a schematic view of the mirror head of the interior rearview mirror assembly with a radar-transmissive cover integrally formed with a mirror casing of the mirror head;

FIG. 11 is a schematic view of the mirror head of the interior rearview mirror assembly with a separate and distinct radar-transmissive cover attached to the mirror casing of the mirror head;

FIG. 12 is a schematic view of the mirror head of the interior rearview mirror assembly with a radar-transmissive housing of the radar sensor module corresponding to an outer surface of the mirror casing of the mirror head;

FIG. 13 shows a polarized film of the mirror reflective element of the interior rearview mirror assembly;

FIGS. 14 and 15 show radar sensor data processed to determine health conditions or vital signs of a driver of the vehicle;

FIG. 16 shows the radar sensor used to detect occupants within the interior cabin of the vehicle; and

FIG. 17 shows the radar sensor used to perform gesture detection for operating an infotainment system of the vehicle.

### DESCRIPTION OF THE PREFERRED EMBODIMENTS

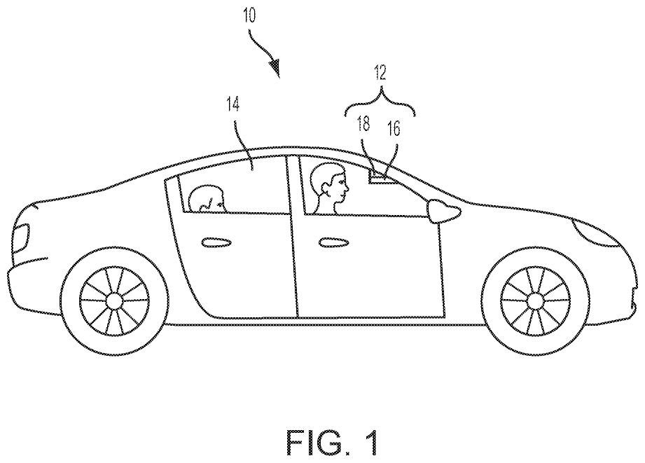

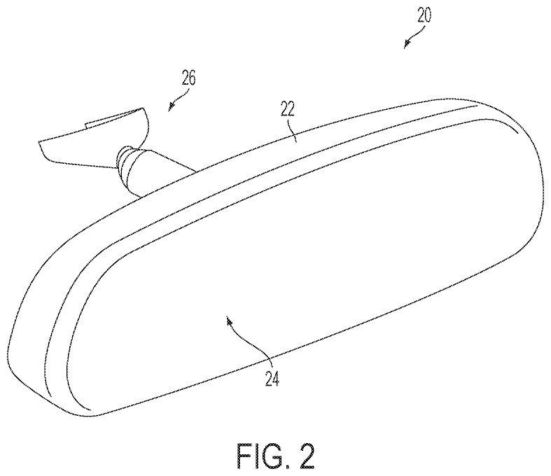

Referring now to the drawings and the illustrative embodiments depicted therein, a vehicular cabin monitoring system 12 for a vehicle 10 is configured to detect presence of occupants within the interior cabin 14 of the vehicle 10 (FIG. 1). For example, the system 12 may include one or more radar sensors 16 disposed at the interior cabin 14 of the vehicle 10 and that sense respective regions of the interior cabin 14 of the vehicle 10. The system 12 further includes a control or electronic control unit (ECU) 18 that includes electronic circuitry and associated software, such as a data processor or image processor for processing sensor data captured by the one or more radar sensors 16, whereby the ECU 18 may process sensor data captured by the one or more radar sensors 16 to detect presence of occupants, determine conditions of the occupants, and the like. The one or more radar sensors 16 and/or the ECU 18 are disposed at an interior rearview mirror assembly 20 of the vehicle (FIG. 2), and in some examples additional radar sensors may be disposed at an overhead console module, a light module (e.g., a reading light or dome light), a grab handle module, and/or at or behind the vehicle headliner. The data transfer or signal communication from the one or more radar sensors 16 to the ECU 18 may comprise any suitable data or communication link, such as a vehicle network bus or the like of the equipped vehicle.

The mirror assembly 20 includes a casing 22 and a reflective element 24 positioned at a front portion of the casing 22. In the illustrated example, the mirror assembly 20 is configured to be adjustably mounted to an interior portion of the vehicle (such as to an interior or in-cabin surface of the vehicle windshield 11 or a headliner of the vehicle or the like) via a mounting structure or mounting configuration or assembly 26. The mirror reflective element 24 may comprise a variable reflectance mirror reflective element that varies its reflectance responsive to electrical current applied to conductive coatings or layers of the reflective element.

The radar sensor 16 is disposed within or at or near the interior rearview mirror assembly 20 for sensing regions of the interior cabin 14 of the vehicle 10. As discussed further below, sensor data captured by the radar sensor 16 is processed by the cabin monitoring system 12 to detect presence of occupants and objects within the vehicle, such as to determine if a child has been left unattended in a parked vehicle or to determine movement of vehicle occupants following a collision. Because the mirror assembly 20 is positioned above or clear of the dashboard, the mirror assembly 20 provides a mounting position for the radar sensor 16 that allows at least some visibility to seating positions within the cabin of the vehicle and for detecting the front foot well regions. Other mounting positions for the radar sensor 16, such as the overhead console module, the central dome light, or above the doors (e.g., a grab handle) may also provide visibility to the foot well regions.

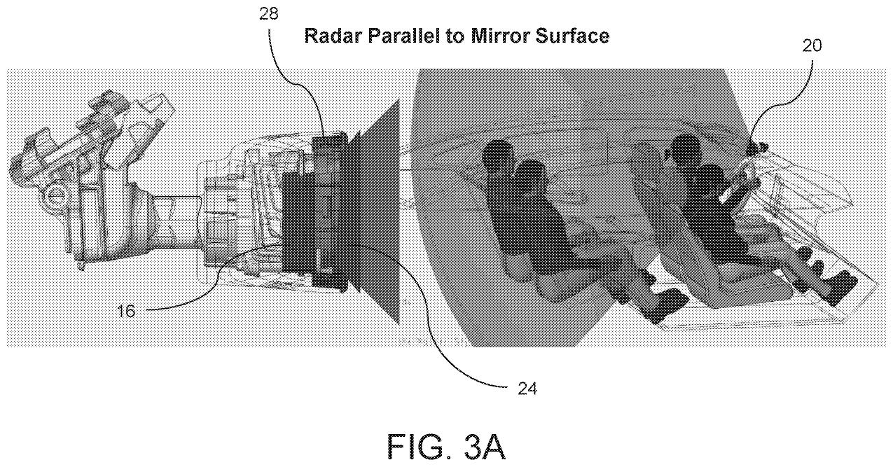

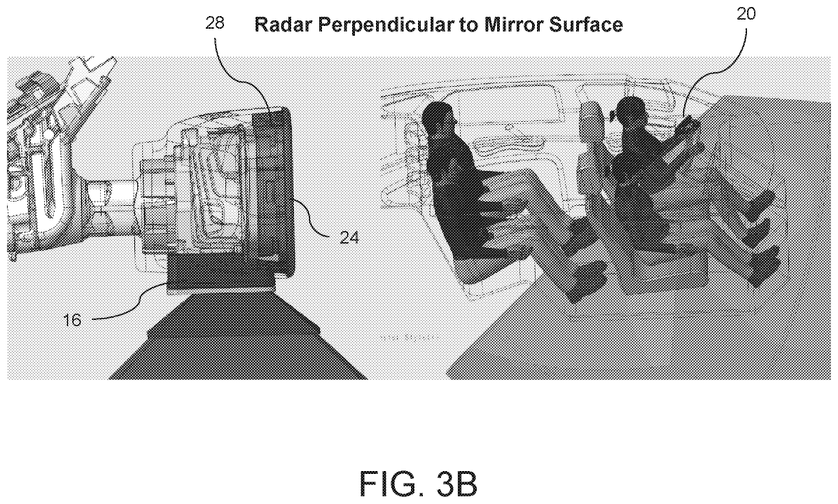

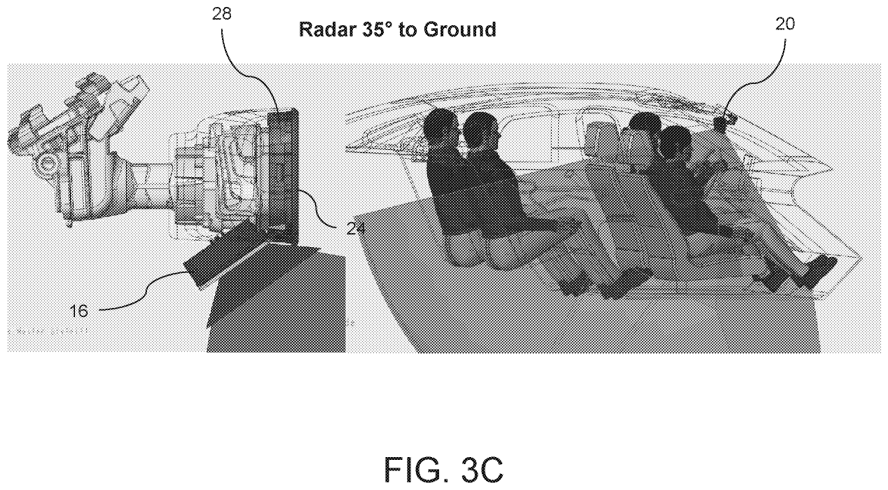

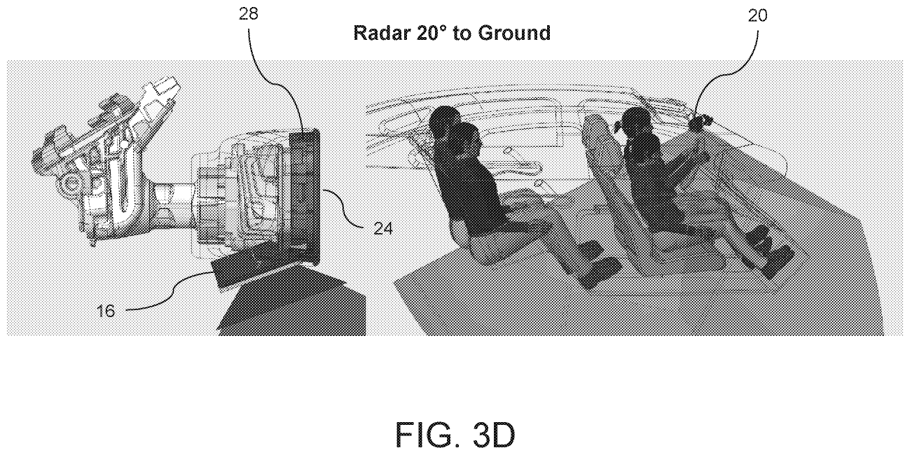

Referring to FIGS. 3A-3D, the radar sensor 16 may be accommodated by the mirror casing 22 behind the mirror reflective element 24 and sense regions of the interior cabin of the vehicle at least partially through the mirror casing 22 and/or the mirror reflective element 24. For example, the radar sensor 16 may be attached or mounted to a mirror back plate 28 that attaches the mirror reflective element 24 to the mirror casing 22. Optionally, the radar sensor 16 may be attached to an inner surface of the mirror casing 22 An orientation of the radar sensor 16 relative to the mirror reflective element 24 may affect the field of sensing of the radar sensor 16. For example, the radar sensor 16 may be disposed substantially parallel to a rear side or inner surface of the mirror reflective element 24 (FIG. 3A). Thus, the field of sensing (which may span about 120 degrees or more) may emanate from the mirror head and have a principal sensing axis substantially perpendicular to the mirror reflective element 24. This may allow the radar sensor 16 to sense objects and/or vehicle occupants in or near rear seating positions of the vehicle (e.g., second row and/or third row or cargo area regions of the vehicle cabin).

In some examples, the radar sensor 16 may be disposed substantially perpendicular to the mirror reflective element 24 (FIG. 3B). Thus, the radar sensor 16 may sense from and/or through a lower portion of the mirror casing and the principal sensing axis of the field of sensing of the radar sensor 16 may be substantially parallel to the mirror reflective element 24. This may allow the radar sensor 16 to sense objects and/or vehicle occupants in or near front seating positions of the vehicle (e.g., the driver region and front passenger region of the vehicle cabin) and front foot wells.

Further, the radar sensor 16 may be disposed at an oblique angle relative to the mirror reflective element 24, such as at a 55 degree angle relative to the plane of the mirror reflective element 24 (i.e., 35 degrees relative to the ground surface) (FIG. 3C), a 70 degree angle relative to the plane of the mirror reflective element 24 (i.e., 20 degrees relative to the ground surface) (FIG. 3D), at a 45 degree angle relative to the plane of the mirror reflective element 24, and the like. This may allow the radar sensor 16 to sense objects and/or vehicle occupants in or near front and rear seating positions of the vehicle.

With the radar sensor 16 disposed within the mirror head, the radar sensor 16 may move together and in tandem with the mirror head when the mirror head is adjusted to set the rearward view for the driver of the vehicle. To accommodate movement of the radar sensor 16 when detecting presence of occupants and/or determining positions of detected objects or occupants within the vehicle cabin, the cabin monitoring system may track the position of the radar sensor 16 and mirror head relative to the mounting structure 26. For example, a position or orientation of the radar sensor 16 may be calibrated based on sensing of reference points within the cabin of the vehicle (e.g., based on sensing of a fixed point like a marker at the dashboard or headliner of the vehicle). In some examples, the radar sensor may be calibrated based on processing of image data captured by a driver monitoring camera and/or occupant monitoring camera, such as by utilizing characteristics of the systems described in U.S. Pat. No. 11,465,561, which is incorporated herein by reference in its entirety. Optionally, the radar sensor may be calibrated based on a standalone position sensor, such as a Hall effect sensor, such as by utilizing characteristics of the systems described in U.S. Publication No. US-2024-0190351, which is incorporated herein by reference in its entirety.

That is, the interior mirror articulates to optimize the angle of reflection for the driver. This may be a manual operation without position or orientation data collected, meaning that the radar orientation may change relative to the cabin without any input provided for the new position. In some examples, the radar sensor may be mounted at an optimal position of the interior mirror assembly for an averaged field of sensing to provide an optimized solution for the radome effect. For example, radar reflective markers may be disposed within the vehicle, or the sensor may be trained based on known object reflections, so that the radar sensor results may be brought back to a reference frame to account for movement of the mirror head and radar sensor. This may use corner reflectors or other ideal reflectors hidden or disposed within fixed positions of the vehicle cabin.

Optionally, this may utilize metallic features (which have a higher efficiency reflection) that the radar reference frame may be trained toward. Further, the radar sensor may not be constantly recalibrated but calibrated at an optimized cycle (such as upon vehicle startup or after a threshold period of time, like 10 minutes or less, 20 minutes or less, 1 hour or less, and the like).

Further, image data captured by a camera integrated with the mirror may be used to update the orientation of the mirror. The reference frame for the radar sensor data may be calibrated based on the determined orientation of the mirror head. For example, the driver monitoring system or occupant monitoring system may be trained to find key markers in the vehicle cabin to determine the position or orientation of the mirror head. This may be trained based on fixed features in the vehicle cabin or a combination of information like seat position and feature selection.

In some examples, relative shift of the radar sensor data may be acceptable to the final use case. That is, recalibration of the radar sensor based on movement of the mirror head may not be necessary to, for example, detect movement within the cabin of a parked vehicle. For example, there may be marking features within the radar sensor data that may indicate where a detected object is located, to provide a coarser orientation. That is, if a detected object is surrounded by known reflections, it may be determined that the object is within the foot well or in the seat of the vehicle. In this way, the position or relative position of a detected object or vehicle occupant is determined based on sensing known objects or markers near the detected object or vehicle occupant. Each stationary feature of the vehicle may have its own radar fingerprint for detecting objects at or near the stationary feature.

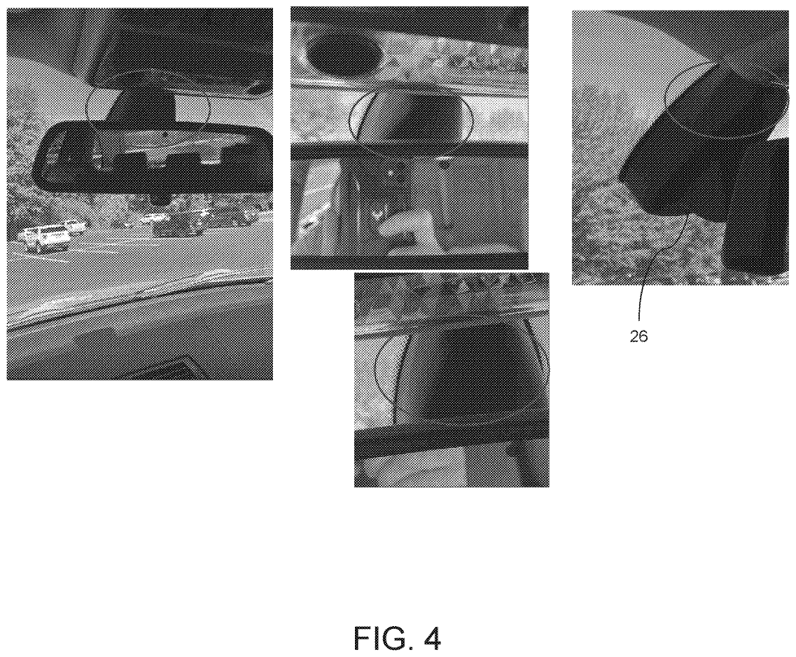

As shown in FIG. 4, the radar sensor 16 may be disposed at or accommodated by other portions of the mirror assembly 20, such as at or within the mounting configuration or mirror stay 26. Mounting the radar sensor 16 within or at the mirror stay 26 may allow the radar sensor 16 to sense from a high elevation within the cabin without having to account for movement of the mirror head. That is, because the mirror head is moved to adjust the rearward view of the driver, the field of sensing of the radar sensor 16 may be changed. The radar sensor 16 may sense above the mirror head and/or below the mirror head.

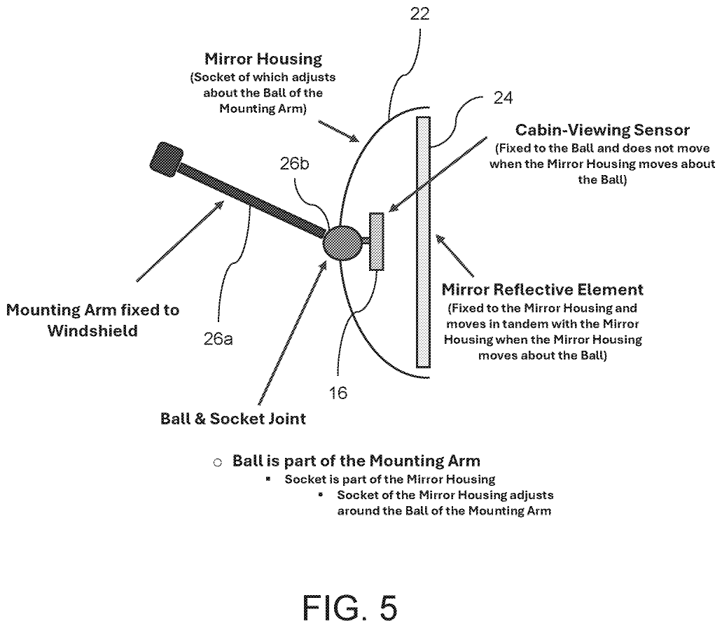

Referring to FIG. 5, the radar sensor 16 may be disposed within the mirror head and fixed relative to the mounting structure 26 so that the mirror head moves relative to the mounting structure 26 and relative to the radar sensor 16 when the mirror head is adjusted to set the rearward view for the driver of the vehicle. For example, the mounting structure 26 may include a mounting arm 26a fixed to the vehicle windshield or the vehicle headliner and a ball member 26b at an end of the mounting arm 26a. The ball member 26b is received by a socket element 30 at the mirror head, such as integrated with the mirror casing 22 or attached to the mirror casing 22, to form a ball and socket joint about which the mirror head is adjusted. That is, the socket element 30 at the mirror head is adjusted about the ball member 26b of the mounting structure 26. The cabin-viewing sensor or radar sensor 16 is fixed relative to the ball member 26b, such as attached to or integrally formed with the ball member 26b, so that the mirror casing 22 and mirror reflective element 24 move about the ball member 26b and radar sensor 16. The radar sensor 16 may be disposed at the ball member 26b to have any suitable field of sensing within the interior cabin of the vehicle. For example, the radar sensor 16 may be oriented generally parallel to the ground surface, perpendicular to the ground surface, or at an oblique angle relative to the ground surface (e.g., FIGS. 3A-3D).

In examples where the mirror assembly includes an electrochromic mirror reflective element, the radar sensor 16 may be disposed so that the radar sensor 16 does not sense through the mirror reflective element. Because metallic coatings of the electrochromic mirror reflective element 16, such as indium doped tin oxide (ITO), may cause signal degradation for the radar sensor 16, the radar sensor 16 may sense through the mirror casing 22 (e.g., from a lower portion of the mirror head), which may be formed with a radome material, and/or be disposed beneath the mirror reflective element 24. That is, avoiding the mirror reflective element 24 may be solved through packaging, where the radar sensor 16 may provide the desired function while sensing in a direction that is not covered by the metallic surface of the mirror (e.g., looking down and packaged at or near perpendicular to the mirror surface to have limited interference). The radar antennas may be packaged below the reflective surfaces of the mirror to sense in any orientation. This may require the antennas to be spaced from the radar chip (e.g., processing circuitry may be disposed spaced from the radar antennas) or at a unique circuit board shape. A small enough chip may enable an antenna on chip solution. In some examples, the radar sensor 16 may be disposed at a chin region of the mirror head, such as by utilizing characteristics of International Publication No. WO 2023/220222, which is hereby incorporated herein by reference in its entirety.

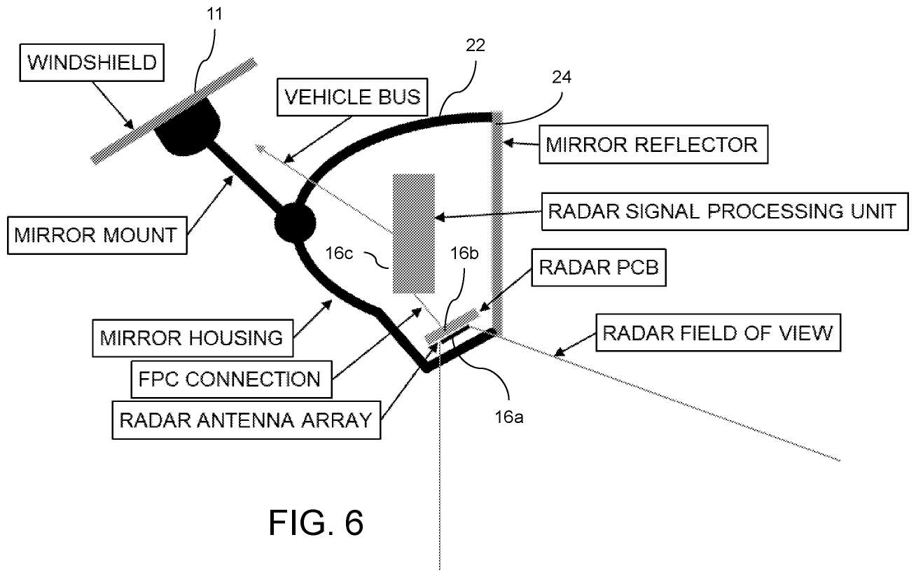

Referring to FIG. 6, the radar sensor 16 may include a radar antenna array 16a disposed at a radar printed circuit board (radar PCB) 16b and a radar signal processing unit or control module 16c. The radar PCB 16b and/or radar control module 16c may include a plurality of transmitters that transmit radio signals via the radar antenna array 16a, a plurality of receivers that receive radio signals via the radar antenna array 16a, with the received radio signals being transmitted radio signals that are reflected from an object present in the field of sensing of the respective radar sensor 16. The signals may be processed at the radar control module 16c for detecting the objects present in the field of sensing of the radar sensor 16. Signals indicative of the detected objects and/or the radar sensor data is transmitted from the radar control module 16c to the vehicle ECU 18, such as via the BUS of the vehicle.

In the illustrated example of FIG. 6, the radar PCB 16b is disposed within the mirror head or mirror casing 22 and remote from the radar signal processing unit 16c. The radar PCB 16b may be electrically connected to the remote radar signal processing unit 16c via a flexible printed circuit (FPC) connection. The radar PCB 16b is disposed at a lower edge region of the mirror head or mirror casing 22 and disposed adjacent to a lower edge region of the mirror reflective element 24 so that a field of sensing of the radar sensor 16 extends at least rearward of the mirror assembly (i.e., toward the driver and passenger regions of the interior cabin of the vehicle) and at least downward below the mirror assembly. For example, the principal sensing axis of the radar sensor 16 may extend at a 45 degree angle downward from the mirror head (e.g., between about 30 degrees and about 60 degrees measured from a horizontal plane). The radar PCB 16b may be positioned so that the field of sensing does not include or sense the mirror reflective element 24, such as to avoid interference from metallic coatings of the mirror reflective element 24. The mirror head 22 may include a flat or planar portion that extends generally perpendicular to the primary sensing axis of the radar PCB 16.

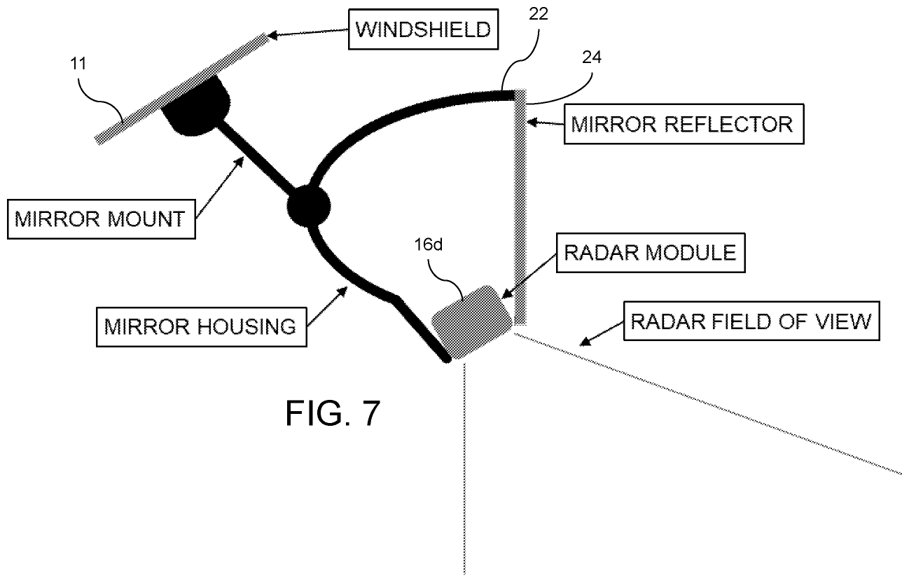

Optionally, the radar sensor 16 may include the radar sensor array 16a, radar PCB 16b and/or the radar signal processing unit 16c accommodated within a housing 16d that is mounted or attached to the mirror casing 22 (FIG. 7). That is, the radar sensor 16 is packaged in a module. This may allow the radar sensor 16 to be certified for compliance as a unit. The radar sensor module 16 may be disposed at the lower edge region or a chin region of the mirror assembly to sense at least rearward from the mirror head and downward from the mirror head. For example, the radar sensor module 16 may be snap attached to the lower edge region of the mirror casing 22 below the lower edge region of the mirror reflective element 24. The mirror assembly with the sensor at the chin region may utilize characteristics of the mirror assemblies described in International Pat. Pub. No. WO 2023/220222, which is incorporated herein by reference in its entirety.

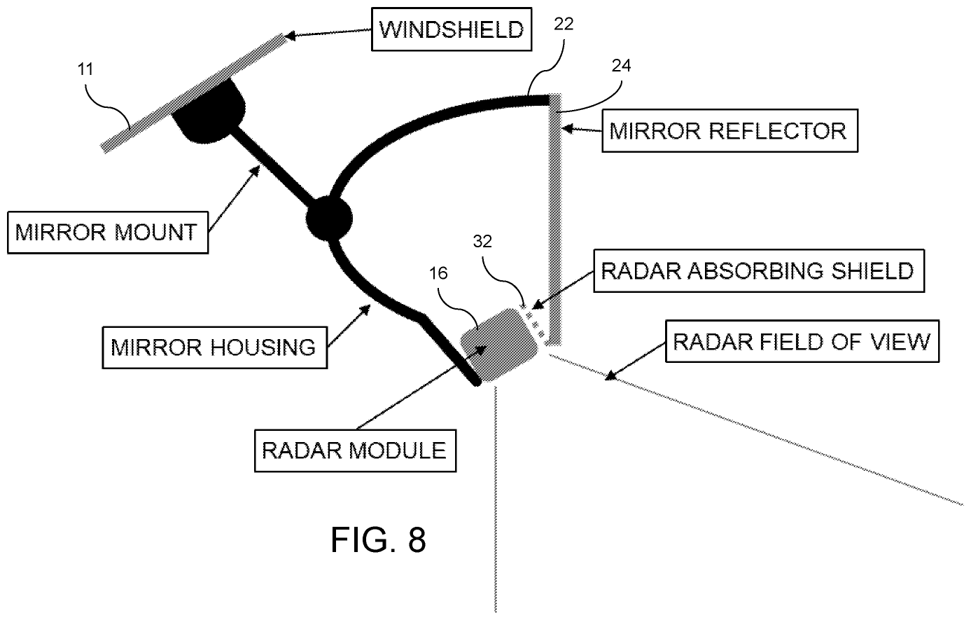

In some examples, a radar shield or radar absorbing material 32 is disposed between the radar sensor 16 and the mirror reflective element 24 (FIG. 8). For example, the radar shield 32 is disposed at a side or portion of the radar sensor 16 facing the mirror reflective element 24 or the radar shield 32 is disposed at a rear side of the mirror reflective element 24 that faces the interior portion of the mirror head accommodating the radar sensor 16. The radar shield 32 absorbs or attenuates radio waves to prevent interference of the metallic mirror reflective coating with the radar sensor 16 or false object detections. Thus, the shielding may be applied to absorb stray reflections from the mirror reflector.

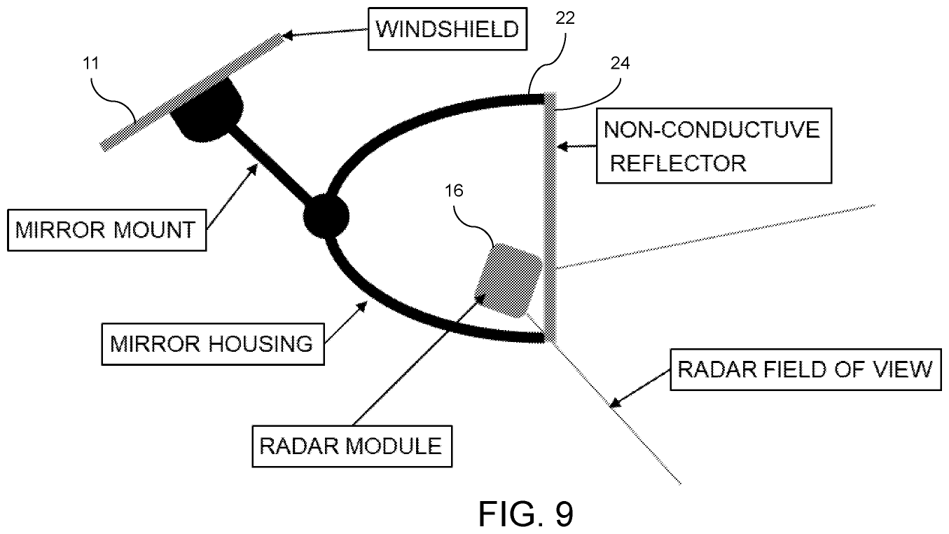

The mirror reflective element 24 may comprise a non-conductive reflector so that the radar sensor 16 may sense through the mirror reflective element without interference or false detection caused by the mirror reflective element 24 (FIG. 9). For example, the mirror reflective element 24 may include a reflective polarizer. This may allow the radar sensor 16 to be mounted within the mirror head 22 and behind the mirror reflective element 24 so that the radar sensor 16 may sense at least partially through the mirror reflective element 24. That is, the field of sensing may be raised so that a principal sensing axis of the radar sensor 16 is higher and the radar sensor 16 senses further rearward in the interior cabin (e.g., to sense a rear seating position like a second row or third row seating position). For example, the principal sensing axis may be at an angle of between about 45 degrees and 10 degrees or parallel relative to a horizontal plane.

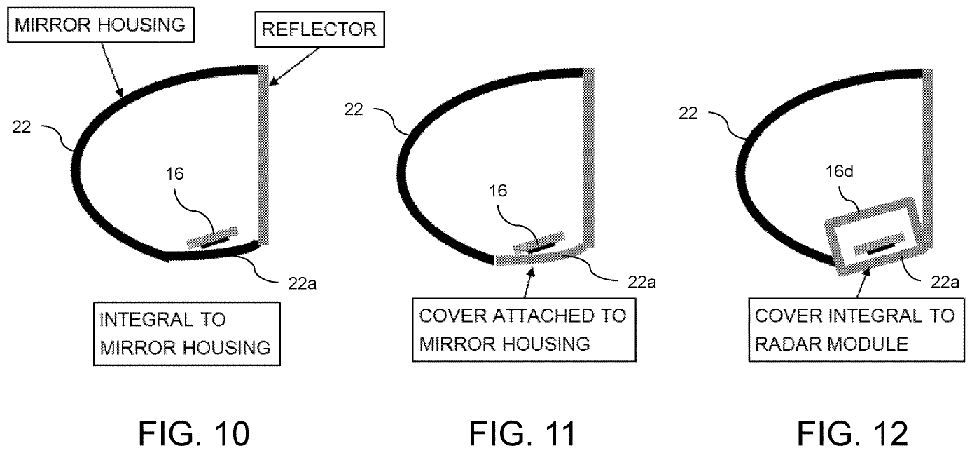

Thus, the radar sensor 16 is disposed within the mirror casing 22 and senses through at least a portion of the mirror casing 22 to sense portions of the interior cabin of the vehicle. That is, radio signals or radio waves emitted by the antenna array 16a may pass through an antenna cover portion 22a of the mirror casing 22, reflect from objects and structure within the interior cabin of the vehicle, and pass back through the antenna cover portion 22a of the mirror casing 22 to be detected or sensed by the antenna array 16a. In some examples, the antenna cover portion 22a may be integrally formed with the mirror casing 22 (FIG. 10). That is, the cover portion 22a comprises a portion of the mirror casing 22 that is at least partially transparent or transmissive of radio waves passing through the cover portion 22a. Optionally, the cover portion 22a comprises a separate component that is attached to the mirror casing 22 (FIG. 11). For example, the cover portion 22a snap attaches to the mirror casing 22 during installation or after installation of the radar sensor 16 within the mirror head. In some examples, the cover portion 22a may be integrally formed with the housing 16d of the radar sensor 16 (FIG. 12). Thus, the radar sensor 16 may be disposed at the mirror casing 22 with at least a portion of the radar housing 16d forming at least part of the outer surface of the mirror casing 22. A portion of the housing 16d may be substantially flush with the outer surface of the mirror casing 22.

Further, the radar antenna may be spaced from the radar processing circuitry and the antennas may be disposed in front of the reflective surface of the mirror. For example, the radar antenna may be disposed between a front glass substrate and a rear glass substrate of the mirror reflective element, with the mirror reflector coating disposed at a front surface of the rear glass substrate and the radar antenna disposed between the mirror reflector coating and the front glass substrate. A thin, visibly near transparent material, such as ITO may provide the antenna.

Optionally, the reflective material may be changed, such as to utilize a polarized wire grid material that is reflective to visible light (e.g., and to the human eye) and with radar polarization and antenna position allowing for the transmission of radar waves through the wire grid material. In other words, a polarized wire grid material may be disposed at the mirror reflective element to at least partially reflect visible light and at least partially transmit radar waves. Optionally, the mirror may include a dielectric material stack that uses materials transmissive to radar but that reflect wavelengths of visible light.

In some examples, the mirror may include a material that is electrically pulsed to change its orientation or light reflectivity and radar transmissive properties, such as a liquid crystal display (LCD). The material may be electrically pulsed at a rate that the human eye is unable to perceive, but that allows radar waves to pass through. The cell size may allow for the radar to transmit without interference. In examples where the material is polymer-based, it may allow for the transmission of radar and only be adjusted to adjust the reflectivity of the mirror for other functions, like night glare.

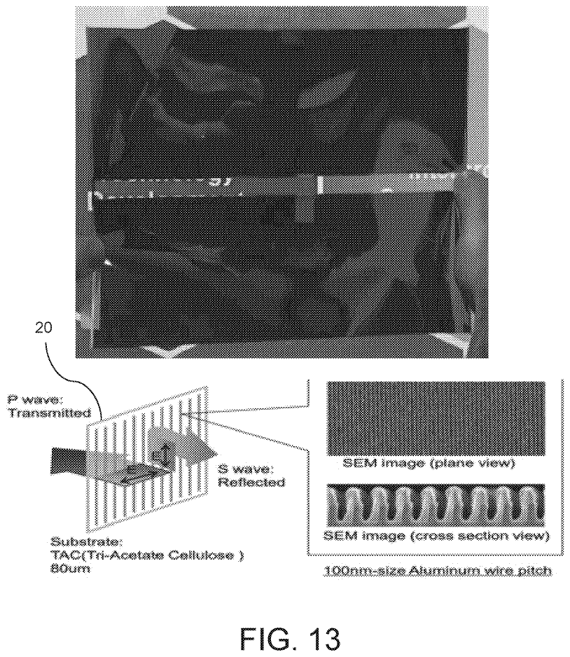

Referring to FIG. 13, the high transmissivity mirror may reflect one direction of linearly polarized light while allowing orthogonal polarization to pass through. The image produced by an LCD may be linearly polarized in a single direction. With the LCD disposed behind the mirror reflective element and the mirror reflective element polarized in the same direction as the LCD, this provides a high efficiency display, such as to provide a video display screen, dynamic overlay at the mirror reflections, a hidden blind zone indicator, a lite chrome handle, localized darkening, and hidden lighting or sensing. In some examples a suspended particle device (SPD) film may be used. This configuration may be used with a radar sensor 16 that senses through the LCD or SPD and the mirror reflective element.

Moreover, mounting positions of the radar sensor 16 may cause the steering column to at least partially block or obscure the ability of the radar sensor 16 to view the front driver side foot well region. Positioning the radar sensor 16 at the furthest region of the mirror head from the front driver side foot well region (e.g., across the vehicle cabin, such as at the right side of the mirror head for a left hand drive vehicle that has the steering wheel at the left side of the vehicle) may increase the field of sensing of the radar sensor 16 that extends beneath the steering column.

To view the rear foot well regions, the radar sensor 16 at or near the mirror assembly may have to sense through the front seating positions. Thus, to view the rear foot well regions, the cabin monitoring system may include additional radar sensors disposed with a more clear line of sensing to the rear foot well regions. For example, the radar sensors may be disposed above one or more rear doors, in a high mounted dome light or a rear mounted overhead console module.

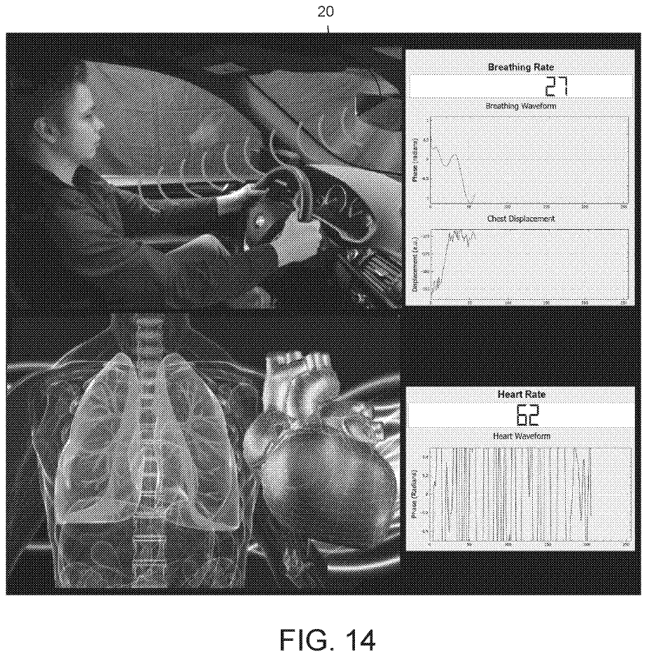

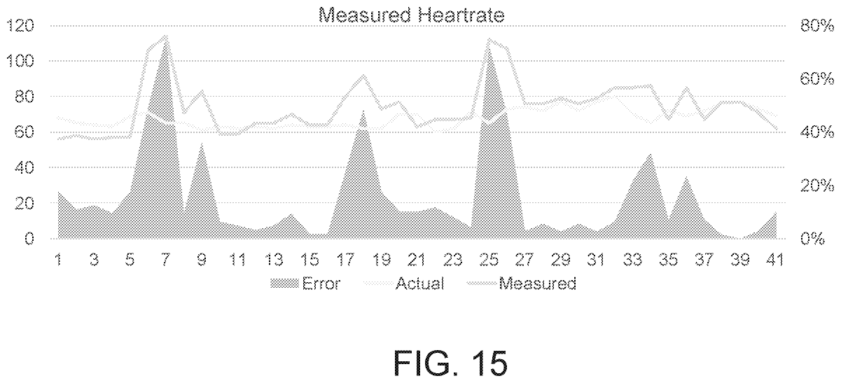

Sensor data captured by the radar sensor disposed at or near the mirror assembly 20 may be utilized for a variety of cabin monitoring functions. For example, sensor data may be captured to detect occupancy of the vehicle, perform driver alertness monitoring, perform vital sign monitoring, and determine driver distress. As shown in FIGS. 14 and 15, radar sensor data may be used to monitor a chest region or torso region of the driver to perform non-intrusive breathing or heart rate sensing. A radar operating at a band of 80 Ghz may be used to detect small movements within the body, including detection through typical clothing. Non-contact vital signs may be useful in monitoring the health of the driver and may be extended to add additional information to driver drowsiness detection systems.

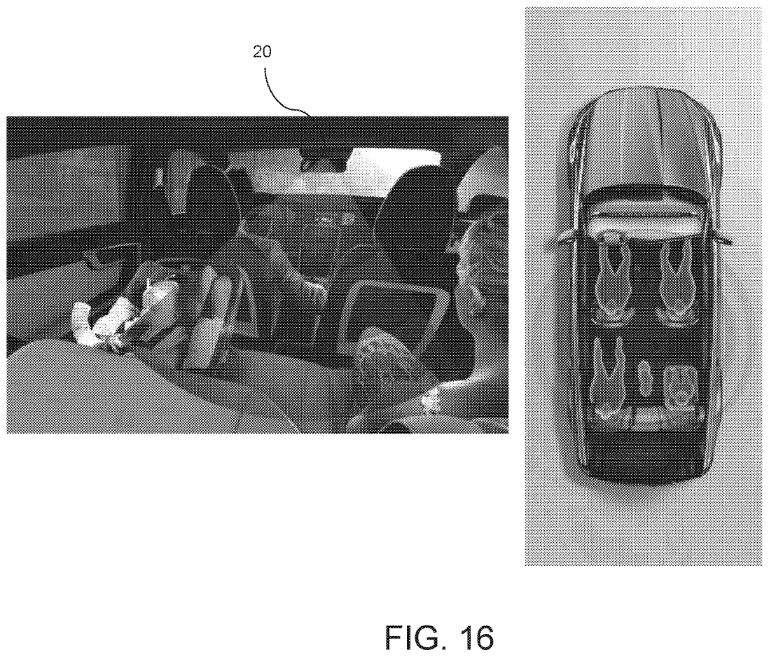

As shown in FIG. 16, the radar can be used for in cabin occupant detection, such as to detect children left unattended in the vehicle. Through the use of doppler signatures, living beings may be separated in sensor data from inanimate objects. Microdoppler information may form the basis of occupancy detection, and can detect the presence of micro-movements inherent in living beings.

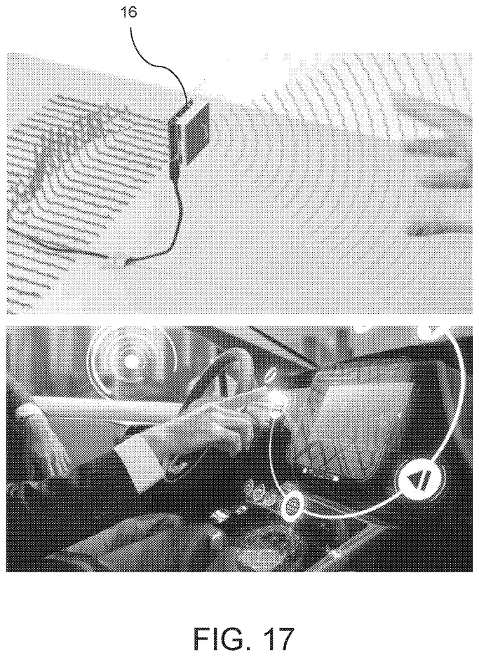

Referring to FIG. 17, radar sensor data may also be used for gesture detection, such as to control operation of an infotainment system of the vehicle at least in part based on gestures performed by a driver of the vehicle. Hand gestures are a natural part of human communication, often making up much of face to face communication. Radar sensing systems have the potential for accurate gesture recognition, given the inherent range and velocity resolution achievable by radar sensors. Range, velocity, azimuth, and elevation data (FMCW 4D) may be fed into a neural network to recognize and detect gestures and adjust operation of one or more systems of the vehicle based on recognized gestures. For example, a hand gesture swiping rightward across an infotainment screen may cause the infotainment system to change songs while an upward hand gesture may increase volume and a downward hand gesture may decrease volume. Data collection for occupant detection may be paused or interrupted to process gesture input, such as responsive to detecting the driver's hands near the infotainment screen. In some examples, this may be achieved based on processing a few frames of data in a second for occupant detection and other frames for gesture detection. Thus, the radar may change modes quickly.

Thus, because the mirror assembly may be disposed at a high mounting location at or near a centerline of the vehicle, the mirror assembly may provide a beneficial mounting position for the cabin monitoring sensor. When paired with a driver monitoring camera and/or an occupant monitoring camera, this provides a mirror head with multiple sensors. Moreover, the mirror assembly may be scalable across different vehicle platforms with minimized tooling and development costs and minimized system costs.

The radar sensor may have a relatively small form factor, such as having a height of less than about 15 mm, when accommodated by the mirror assembly. Moreover, the radar sensor may have a relative large field of view or field of sensing (e.g., about 120 degrees or more) and utilize low power. In some examples, the radar sensor may operate at bands of 120 Ghz or 80 Ghz or 60 Ghz. Moreover, the radar may have a footprint of about 10 mm by 10 mm or less. The radar sensor 16 may use a 4 TX antenna by 4 RX antenna MIMO deployment. A higher band, such as 120 Ghz may provide better vital sign detection, better out of position detection, better range resolution, better accuracy, and a better microdoppler.

The radar sensor may operate at a frequency of about 120 GHz (e.g., between about 122 GHz and 123 GHz). This high frequency may provide a finer resolution with a smaller antenna array (e.g., a 10 millimeter by 10 millimeter package). In some examples, the radar sensor may operate at a frequency of about 60 GHz (e.g., between about 61 GHz and 61.5 GHz). This lower frequency may provide deeper penetration and longer sensing range. Optionally, the radar sensor may operate at a frequency of about 80 GHz (e.g., between about 78 GHz and 82 GHz).

The radar sensor may have a small footprint to be easily packaged within the interior rearview mirror assembly mirror head. The radar module may have an integrated cover over the antenna array that becomes part of the visible housing of the mirror, or the antenna covering may be a separate component attached to the housing of the mirror, or the covering may be integral to the mirror housing. The mirror assembly or radar module may contain an absorptive shield to prevent stray reflections from mirror components from interfering. The mirror reflector may be made from a non-conductive or other radar-transmitting material, allowing the radar module to be mounted behind the reflective surface. The processing of radar signals into useable DMS/OMS information can be done within the radar module, within a separate module or PCB in the mirror, or within a separate ECU within the vehicle remote from the mirror assembly. Filtering and power conditioning for the module may be done within the radar module, or on a separate PCB within the mirror head.

Further, the mirror assembly and cabin monitoring system may satisfy regulatory requirements, such as for child presence detection (e.g., to detect life presence even when not visible, such as under a blanket), health monitoring (e.g., vital signs), life detection, occupant monitoring (e.g., out of position), stature classification, driver drowsiness, security monitoring (e.g., sentry mode or intrusion alert), and the like. The system may provide enhanced feature performance via fusion of the radar sensor with vision systems. That is, the camera may enhance radar features and the radar may enhance camera features. This may replace seat mat and weight sensors and enhance gesture control using radar and camera sensors.

In some examples, one or more radar sensors may be disposed elsewhere in the vehicle cabin, such as at an overhead console module or sensor farm, such as described in International Publication No. WO 2006/063827, which is hereby incorporated herein by reference in its entirety.

The cabin monitoring system and radar sensor may utilize characteristics of the cabin monitoring systems described in U.S. Pat. No. 12,235,389 and/or U.S. Patent Publication No. US-2026-0105826 and/or U.S. patent application Ser. No. 19/641,731, filed Apr. 8, 2026 (Attorney Docket MAG04 P5562); Ser. No. 19/641,750, filed Apr. 8, 2026 (Attorney Docket MAG04 P5563); Ser. No. 19/642,874, filed Apr. 9, 2026 (Attorney Docket MAG04 P5565); Ser. No. 19/640,588, filed Apr. 7, 2026 (Attorney Docket MAG04 P5566) and/or Ser. No. 19/640,760, filed Apr. 7, 2026 (Attorney Docket MAG04 P5567), which are all hereby incorporated herein by reference in their entireties.

The interior mirror assembly may comprise a dual-mode interior rearview video mirror that can switch from a traditional reflection mode to a live-video display mode, such as is by utilizing aspects of the mirror assemblies and systems described in U.S. Pat. No. 11,242,008; 11,214,199; 10,442,360; 10,421,404; 10,166,924; 10,046,706 and/or 10,029,614, and/or U.S. Publication Nos. US-2024-0064274; US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

The reflective element and mirror casing are adjustable relative to a base portion or mounting assembly to adjust the driver's rearward field of view when the mirror assembly is normally mounted at or in the vehicle. The mounting assembly may comprise a single-ball or single-pivot mounting assembly, whereby the reflective element and casing are adjustable relative to the vehicle windshield (or other interior portion of the vehicle) about a single pivot joint, or the mounting assembly may comprise other types of mounting configurations, such as a double-ball or double-pivot mounting configuration or the like.

The socket or pivot element is configured to receive a ball member of the base portion, such as for a single pivot or single ball mounting structure or a double pivot or double ball mounting structure or the like (such as a pivot mounting assembly of the types described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860 and/or 6,483,438, which are hereby incorporated herein by reference in their entireties).

The mounting base includes an attaching portion that is configured to be attached to an interior surface of a vehicle windshield (such as to a mounting button or attachment element adhered to the interior surface of the vehicle windshield or such as to a headliner or overhead console of the vehicle). The mounting base may comprise a metallic ball portion or may comprise a molded (such as injection molded) polymeric mounting base or may be otherwise formed, depending on the particular application of the mirror assembly.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

As discussed above, the mirror assembly may comprise an electro-optic or electrochromic mirror assembly that includes an electro-optic or electrochromic variably reflective mirror reflective element. The perimeter edges of the reflective element may be encased or encompassed by the perimeter element or portion of the bezel portion to conceal and contain and envelop the perimeter edges of the substrates and the perimeter seal disposed therebetween. The variably reflective mirror reflective element of the mirror assembly may utilize aspects of the mirror reflective elements described in commonly assigned U.S. Pat. Nos. 7,626,749; 7,274,501; 7,255,451; 7,195,381; 7,184, 190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, and/or U.S. Publication No. US-2022-0371513, which are hereby incorporated herein by reference in their entireties.

Although shown as an electrochromic mirror application, it is envisioned that the mirror assembly may comprise a prismatic reflective element. The prismatic mirror assembly may be mounted or attached at an interior portion of a vehicle (such as at an interior surface of a vehicle windshield) via the mounting means described above, and the reflective element may be toggled or flipped or adjusted between its daytime reflectivity position and its nighttime reflectivity position via any suitable toggle means, such as by utilizing aspects of the mirror assemblies described in U.S. Pat. No. 6,318,870 and/or 7,249,860, and/or U.S. Publication No. US-2010-0085653, which are hereby incorporated herein by reference in their entireties. Optionally, for example, the interior rearview mirror assembly may comprise a prismatic mirror assembly, such as the types described in U.S. Pat. Nos. 7,289,037; 7,249,860; 6,318,870; 6,598,980; 5,327,288; 4,948,242; 4,826,289; 4,436,371 and/or 4,435,042, which are hereby incorporated herein by reference in their entireties. Optionally, the prismatic reflective element may comprise a conventional prismatic reflective element or prism or may comprise a prismatic reflective element of the types described in U.S. Pat. Nos. 7,420,756; 7,289,037; 7,274,501; 7,249,860; 7,338,177 and/or 7,255,451, which are all hereby incorporated herein by reference in their entireties.

The mirror assembly may include a camera or sensor or light of a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 12,403,834; 12,393,089; 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2025-0329174; US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2026/019985 and/or WO 2025/231198, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587, 186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide driver monitoring or occupant monitoring) responsive to processing of the data captured by the radar sensors. The radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

Changes and modifications in the specifically described embodiments may be carried out without departing from the principles of the present invention, which is intended to be limited only by the scope of the appended claims as interpreted according to the principles of patent law.

1. A vehicular cabin monitoring system, the vehicular cabin monitoring system comprising:
a vehicular interior rearview mirror assembly comprising a mirror head adjustable relative to a mounting structure, wherein the mounting structure is configured to mount the vehicular interior rearview mirror assembly at an interior portion of an interior cabin of a vehicle;
wherein the mirror head accommodates a mirror reflective element;
wherein a radar sensor is accommodated by the mirror head, and wherein, with the vehicular interior rearview mirror assembly mounted at the interior portion of the interior cabin of the vehicle, the radar sensor senses within the interior cabin of the vehicle;
wherein the mirror reflective element moves together and in tandem with the mirror head when, with the vehicular interior rearview mirror assembly mounted at the interior portion of the interior cabin of the vehicle, the mirror head is adjusted to set a rearward view for a driver of the vehicle;
wherein the radar sensor comprises an antenna array that, when the radar sensor is operated to sense within the interior cabin of the vehicle, (i) emits radio waves that pass through a portion of the mirror head and (ii) receives radio waves that reflect from objects within the interior cabin of the vehicle and pass through the portion of the mirror head;
an electronic control unit (ECU);
wherein sensor data captured by the radar sensor is transferred to the ECU;
wherein the ECU comprises electronic circuitry and associated software, and wherein the electronic circuitry of the ECU comprises a processor operable to process sensor data captured by the radar sensor and transferred to the ECU; and
wherein the vehicular cabin monitoring system, via processing at the ECU of sensor data captured by the radar sensor, monitors at least a driver of the vehicle.

2. The vehicular cabin monitoring system of claim 1, wherein the radar sensor moves together and in tandem with the mirror head when, with the vehicular interior rearview mirror assembly mounted at the interior portion of the interior cabin of the vehicle, the mirror head is adjusted to set the rearward view for the driver of the vehicle.

3. The vehicular cabin monitoring system of claim 2, wherein the vehicular cabin monitoring system determines movement of the mirror head relative to the mounting structure, and wherein the vehicular cabin monitoring system determines position of an object within the interior cabin of the vehicle sensed by the radar sensor based at least in part on the determined movement of the mirror head about the mounting structure.

4. The vehicular cabin monitoring system of claim 3, wherein the vehicular cabin monitoring system determines movement of the mirror head about the mounting structure based on the radar sensor sensing one or more radar reflective markers at fixed positions within the interior cabin of the vehicle.

5. The vehicular cabin monitoring system of claim 1, wherein the radar sensor is fixed relative to movement of the mirror head.

6. The vehicular cabin monitoring system of claim 5, wherein the mounting structure comprises (i) a mounting arm configured to mount at the interior portion of the interior cabin of the vehicle and having a ball member disposed at an end of the mounting arm and (ii) a socket element disposed at the mirror head and configured to adjustably receive the ball member, and wherein the mirror head and socket element are adjustable about the ball member, and wherein the radar sensor is disposed at the ball member.

7. The vehicular cabin monitoring system of claim 1, wherein the radar sensor is attached to the mirror head at a mounting plane, and wherein the mounting plane is parallel to a rear side of the mirror reflective element.

8. The vehicular cabin monitoring system of claim 1, wherein the radar sensor is attached to the mirror head at a mounting plane, and wherein the mounting plane is perpendicular to a rear side of the mirror reflective element.

9. The vehicular cabin monitoring system of claim 1, wherein the radar sensor is attached to the mirror head at a mounting plane, and wherein the mounting plane is at an oblique angle relative to a rear side of the mirror reflective element.

10. The vehicular cabin monitoring system of claim 1, wherein the portion of the mirror head comprises the mirror reflective element.

11. The vehicular cabin monitoring system of claim 10, wherein the mirror reflective element comprises an electrochromic mirror reflective element having a metallic mirror reflector coating at a front side of a rear glass substrate of the electrochromic mirror reflective element, and wherein the antenna array of the radar sensor is disposed between the metallic mirror reflector coating and a rear side of a front glass substrate of the electrochromic mirror reflective element.

12. The vehicular cabin monitoring system of claim 1, wherein the radar sensor is accommodated by the mounting structure of the vehicular interior rearview mirror assembly.

13. The vehicular cabin monitoring system of claim 1, wherein sensor data captured by the radar sensor is processed to determine a health condition of the driver of the vehicle.

14. The vehicular cabin monitoring system of claim 1, wherein sensor data captured by the radar sensor is processed to detect occupants within the interior cabin of the vehicle.

15. The vehicular cabin monitoring system of claim 1, wherein sensor data captured by the radar sensor is processed to perform gesture recognition.

16. The vehicular cabin monitoring system of claim 1, wherein the radar sensor is disposed behind the mirror reflective element, and wherein the portion of the mirror head comprises a lower edge portion of a mirror casing.

17. The vehicular cabin monitoring system of claim 16, wherein a radio wave absorbing shield is disposed between the radar sensor and the mirror reflective element.

18. The vehicular cabin monitoring system of claim 16, wherein the radar sensor is disposed behind the mirror reflective element, and wherein the portion of the mirror head comprises a cover disposed at the lower edge portion of the mirror casing, and wherein the cover is snap-attached at the lower edge portion of the mirror casing.

19. A vehicular cabin monitoring system, the vehicular cabin monitoring system comprising:
a vehicular interior rearview mirror assembly comprising a mirror head adjustable relative to a mounting structure, wherein the mounting structure is configured to mount the vehicular interior rearview mirror assembly at an interior portion of an interior cabin of a vehicle;
wherein the mirror head accommodates a mirror reflective element;
wherein a radar sensor is accommodated by the mirror head, and wherein, with the vehicular interior rearview mirror assembly mounted at the interior portion of the interior cabin of the vehicle, the radar sensor senses within the interior cabin of the vehicle;
wherein the mirror reflective element and the radar sensor move together and in tandem with the mirror head when, with the vehicular interior rearview mirror assembly mounted at the interior portion of the interior cabin of the vehicle, the mirror head is adjusted to set a rearward view for a driver of the vehicle;
wherein the radar sensor comprises an antenna array that, when the radar sensor is operated to sense within the interior cabin of the vehicle, (i) emits radio waves that pass through a portion of the mirror head and (ii) receives radio waves that reflect from objects within the interior cabin of the vehicle and pass through the portion of the mirror head;
wherein the antenna array of the radar sensor is disposed behind the mirror reflective element, and wherein the antenna array emits radio waves and receives radio waves that pass through a lower edge portion of a mirror casing of the mirror head;
an electronic control unit (ECU);
wherein sensor data captured by the radar sensor is transferred to the ECU;
wherein the ECU comprises electronic circuitry and associated software, and wherein the electronic circuitry of the ECU comprises a processor operable to process sensor data captured by the radar sensor and transferred to the ECU; and
wherein the vehicular cabin monitoring system determines movement of the mirror head relative to the mounting structure, and wherein the vehicular cabin monitoring system determines position of an object within the interior cabin of the vehicle sensed by the radar sensor based at least in part on the determined movement of the mirror head about the mounting structure.

20. The vehicular cabin monitoring system of claim 19, wherein the vehicular cabin monitoring system determines movement of the mirror head about the mounting structure based on the radar sensor sensing one or more radar reflective markers at fixed positions within the interior cabin of the vehicle.

21. The vehicular cabin monitoring system of claim 19, wherein a radio wave absorbing shield is disposed between the antenna array of the radar sensor and the mirror reflective element.

22. The vehicular cabin monitoring system of claim 19, wherein the vehicular cabin monitoring system, via processing at the ECU of sensor data captured by the radar sensor, monitors at least a driver of the vehicle.

23. A vehicular cabin monitoring system, the vehicular cabin monitoring system comprising:
a vehicular interior rearview mirror assembly comprising a mirror head adjustable relative to a mounting structure, wherein the mounting structure is configured to mount the vehicular interior rearview mirror assembly at an interior portion of an interior cabin of a vehicle;
wherein the mirror head accommodates an electrochromic mirror reflective element;
wherein a radar sensor is accommodated by the mirror head, and wherein, with the vehicular interior rearview mirror assembly mounted at the interior portion of the interior cabin of the vehicle, the radar sensor senses within the interior cabin of the vehicle;
wherein the electrochromic mirror reflective element and the radar sensor move together and in tandem with the mirror head when, with the vehicular interior rearview mirror assembly mounted at the interior portion of the interior cabin of the vehicle, the mirror head is adjusted to set a rearward view for a driver of the vehicle;
wherein the radar sensor comprises an antenna array that, when the radar sensor is operated to sense within the interior cabin of the vehicle, (i) emits radio waves that pass through a portion of the mirror head and (ii) receives radio waves that reflect from objects within the interior cabin of the vehicle and pass through the portion of the mirror head;
wherein the electrochromic mirror reflective element comprises a metallic mirror reflector coating at a front side of a rear glass substrate of the electrochromic mirror reflective element, and wherein the antenna array of the radar sensor is disposed between the metallic mirror reflector coating and a rear side of a front glass substrate of the electrochromic mirror reflective element;
an electronic control unit (ECU);
wherein sensor data captured by the radar sensor is transferred to the ECU;
wherein the ECU comprises electronic circuitry and associated software, and wherein the electronic circuitry of the ECU comprises a processor operable to process sensor data captured by the radar sensor and transferred to the ECU; and
wherein the vehicular cabin monitoring system determines movement of the mirror head relative to the mounting structure, and wherein the vehicular cabin monitoring system determines position of an object within the interior cabin of the vehicle sensed by the radar sensor based at least in part on the determined movement of the mirror head about the mounting structure.

24. The vehicular cabin monitoring system of claim 23, wherein the vehicular cabin monitoring system, via processing at the ECU of sensor data captured by the radar sensor, monitors at least a driver of the vehicle.
